(19) United States
(12) Patent Application Publication
(10) Pub. No.: US 2011/0008029 A1
(43) Pub. Date: Jan. 13, 2011

(54) CULINARY ELECTRIC HOT WATER APPLIANCE WITH AUTOMATIC SWITCH

(76) Inventor: Michael Von Seidel, Western Cape Province (ZA)

Correspondence Address: MEYERTONS, HOOD, KIVLIN, KOWERT & GOETZEL, P.C., P.O. BOX 398, AUSTIN, TX, 78767-0398, US

(21) Appl. No.: 12/864,799

(22) PCT Filed: Jan. 19, 2009
(86) PCT No.: PCT/IB09/00078

§ 371 Date: Jul. 27, 2010

(30) Foreign Application Priority Data
Jan. 29, 2008 (ZA) 2008/00867

(51) Int. Cl. A47J 27/21; H05B 1/02

(52) U.S. Cl. 392/444; 219/490

(57) ABSTRACT

An automatic switch (3) for an electric domestic appliance (1, 13, 33, 36) is provided. The switch comprises a base (4) and associated electronic circuitry (8) for inclusion in an electric power supply circuit that includes a heating element whereby liquid in a container may be heated to boiling temperature. The switch includes a sensor (7, 18) for monitoring radiation emanating from the surface (6) of liquid to be boiled in a container and preferably also a radiation source (5, 19) to produce radiation that is reflected off the liquid surface. The sensor is configured to provide a first output associated with radiation sensed whilst a generally quiescent state of the surface prevails, and to provide a second output associated with radiation sensed when a generally turbulent state of the surface of the liquid prevails that is associated with the onslaught of boiling of the liquid. The change of state from the first output to the second output is operative to trigger a switching action in the electronic circuitry to open the electric power supply circuit. The electronic circuitry may include a first time delay arranged to open said electric power supply circuit a predetermined time period after said change of state from the first output to the second output and may also include a second time delay adapted to open said electric power supply circuit after a predetermined period of time in excess of a predetermined maximum time period permitted by the timer for heating liquid in the container.

### FIELD OF THE INVENTION

This invention relates in particular to a culinary electric hot water appliance of the general nature of an electric kettle or other electric water heater typically having an automatic switch for turning the appliance off. More especially, but not exclusively, the invention relates to an appliance used for heating water for preparing, inter alia, hot beverages.

The invention relates, inter alia, to an electric hot water appliance having a hot surface such as that of an immersion heating element located generally towards the bottom of a container or an externally heated container bottom. The container is typically a kettle, jug or mug (which term is used herein to include a cup, mug or any other drinking vessel from which the beverage made in it is consumable directly). In the instance of a jug or mug, an immersion heating element may be of the “over the side” type with a hot part located at its lower end carried by upwardly extending cold limbs.

Application of the invention also extends to other domestic situations in which boiling, more especially simmering, of water in a container such as a cooking vessel is carried out.

### BACKGROUND TO THE INVENTION

Most electric kettles are fitted with a heat operated automatic switch that serves to turn the kettle off when the water boils, and wherein a bimetallic component of the switch is heated by steam generated by the boiling activity. At least some of these switches require an appreciable amount of steam to be generated before they are actuated. Applicant understands that it is acceptable in the trade that boiling continue for a period of from 10 to 15 seconds before the switch is activated. All of the electrical energy consumed in generating such steam is wasted and the relevant heat is generally dissipated in a useless manner thereby simply contributing unnecessarily to warming of the environment. Such wasted electrical energy can amount to 5 to 10 percent of the total electrical energy consumed during the boiling of a kettle.

It is, of course, possible to utilise a switch that is operative to switch off the electrical power supply to the heating element at a predetermined temperature that is short of boiling point utilising a temperature dependent switch in the manner indicated in my international patent application number PCT/IB2006/002959 entitled “IMMERSION WATER HEATER PARTICULARLY FOR PREPARING HOT BEVERAGES AND THE LIKE”. However, this may not be acceptable to many, as the water will not be “seen to be boiling”.

### OBJECT OF THE INVENTION

It is one object of this invention to provide a culinary electric hot water appliance that will exhibit at least some saving in electrical energy consumption when compared to appliances fitted with steam activated electrical switches.

It is another object of the invention to provide a control unit for use in association with domestic cooking utensils for regulating the boiling thereof.

### SUMMARY OF THE INVENTION

In accordance with one aspect of the invention there is provided an automatic switch for an electric domestic appliance comprising a base and associated electronic circuitry for inclusion in, or for association with, an electric power supply circuit that includes a heating element whereby liquid in a container may be heated to boiling temperature, the automatic switch being characterised in that it includes a sensor for monitoring radiation emanating from the surface of liquid to be boiled in a container and wherein the sensor is configured to provide a first output associated with radiation sensed whilst a generally quiescent state of the surface prevails, and to provide a second output associated with radiation sensed when a generally turbulent state of the surface of the liquid prevails such turbulent state being associated with the onslaught of boiling of the liquid, wherein the change of state from the first output to the second output is operative to trigger a switching action in the electronic circuitry.

Further features of this aspect of the invention provide for the radiation to be either radiation originating in the liquid to be boiled or, preferably, reflected radiation originating with a radiation source forming part of the switch; for the radiation source to be directed generally downwards towards the surface of liquid in the container in which instance the sensor is configured to sense reflected radiation; for the radiation source to be a source of visible light, typically a light emitting diode, in which instance the radiation source may serve also as an indicator as to when the appliance is “on” or, alternatively, for the radiation to be of the infra red or laser variety; for the electronic circuitry to optionally include a first time delay arranged to open said electric power supply circuit a predetermined time period after said change of state from the first output to the second output, said first time delay being of the order of a ½ to 3 seconds; for the electronic circuitry to include a second time delay adapted to open said electric power supply circuit after a predetermined period of time in excess of a predetermined maximum time period permitted by the timer for heating liquid in the container; and for the switch to include a pushbutton operated switch to effect initial closure of the electrical power supply circuit to a heating element associated with an appliance to which automatic switch is fitted, in use.

In accordance with a second aspect of the invention there is provided a water heating appliance including an automatic switch as defined above and an electrical heating element located in a lower region of a container in which water to be heated is operatively contained and wherein the automatic switch is connected to open a power supply circuit to the electrical heating element consequent on said change of state to said second output and a manually operable switch is included in the power supply circuit to initially close same and activate the automatic switch.

Further features of the second aspect of the invention provide for the water heating appliance to be selected from a kettle and an appliance having an “other side” immersion heating element with generally operatively upright limbs extending into an open top of a container in use whereby the hot section of the heating element is supported towards the bottom of the relevant container.

In accordance with a third aspect of the invention there is provided a boiling activated control device comprising a sensor unit and a control unit including control circuitry for controlling an electrical power supply to an electric heating element, the sensor unit and control unit having communications means for communicating from the sensor unit to the control unit, the boiling activated control device being characterised in that the sensor unit includes a sensor for monitoring radiation emanating from the surface of liquid in a container that is operatively heated by the electric heating element and wherein the sensor is configured to provide a first output associated with radiation sensed whilst a generally quiescent state of the surface prevails, and to provide a second output associated with radiation sensed when a generally turbulent state of the surface of the liquid prevails such turbulent state being associated with the onslaught of boiling of the liquid, wherein the change of state from the first output to the second output is operatively communicated to the control unit to trigger a control action in the control circuitry.

Further features of the third aspect of the invention provide for the container to be either a kettle of the so-called “cordless” type in which instance the sensor unit is associated with the kettle and the control unit is associated with a stand for the kettle that removably receives the kettle for use in which instance the control action is simply switching the power to the kettle off, or, alternatively, for the sensor unit to be adapted to be associated with a cooking vessel as a simmer control in which instance the control unit is associated with a cooking energy source and the control action is switching electrical power on and off with any suitable time delays optionally being imposed by the control unit with a view to controlling the frequency of switching; for the communication from the sensor unit to the control unit to be wireless; for the sensor unit to have a battery power supply; for the sensor unit to be adapted to be supported on the edge of a cooking vessel, on a lid, or the like; and for other appropriate features of the automatic switch defined above with regard to the first and second aspects of the invention to be employed on the boiling activated control device of the third aspect of the invention.

The invention also provides a sensor for monitoring radiation emanating from a surface of liquid to be boiled in a container, the sensor being operative to provide a first output associated with radiation sensed whilst a generally quiescent state of the surface prevails, and to provide a second output associated with radiation sensed when a generally turbulent state of the surface of the liquid prevails such turbulent state being associated with the onslaught of boiling of the liquid, wherein the change of state from the first output to the second output is suitable for triggering a switching action in an electronically activated switching circuit.

In order that the above and other features of the invention may be more fully understood various different embodiments thereof will now be described with reference to the accompanying drawings.

### BRIEF DESCRIPTION OF THE DRAWINGS

In the drawings:—

FIG. 1 is a schematic side elevation illustrating one embodiment of kettle fitted with an automatic switch according to the invention;

FIG. 2 is a schematic side elevation illustrating a second embodiment of kettle fitted with an automatic switch according to the invention;

FIG. 3 is a block diagram of the circuit of a simple form of the invention;

FIG. 4 is a block diagram of a more sophisticated automatic switch according to the invention;

FIG. 5 is a schematic side elevation of a simple embodiment of immersion heater assembly fitted with an automatic switch according to the invention;

FIG. 6 illustrates schematically a cooking pot and hot plate fitted with a boiling activated control device in the form of a simmer control device according to the third aspect of the invention;

FIG. 7 is an illustration similar to FIG. 7 but illustrating schematically a “cordless” kettle fitted with a boiling activated control device according to the third aspect of the invention; and,

FIG. 8 is a block diagram of one embodiment of boiling activated control device according to the invention.

### DETAILED DESCRIPTION WITH REFERENCE TO THE DRAWINGS

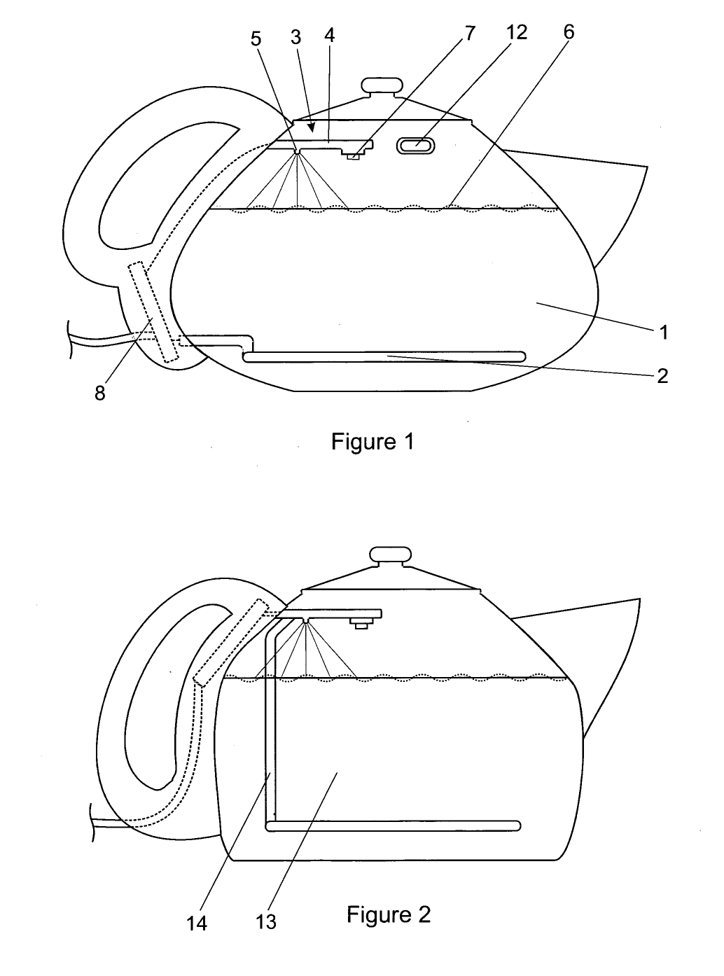

In the embodiment of the invention illustrated in FIG. 1, an automatic switch according to the invention is applied to an appliance in the form of an electric kettle (1) of substantially conventional design and having an electrical immersion heating element (2) towards the bottom thereof with the electrical connection (illustrated simplistically in the drawing) being through the wall of the kettle towards the bottom.

The automatic switch (3) of the invention includes a generally horizontal base (4) projecting outwards from the top of the inside of the kettle. The base supports a radiation source, in this instance a source of visible light in the form of a light emitting diode (5), directed generally downwards towards the surface (6) of water in the kettle. The base also supports a sensor (7) that is configured to sense radiation emanating from the surface of liquid, in this instance reflected by the surface and, in particular, to sense fluctuations in the form of flickering of such radiation or changes in the general pattern of radiation received by it. There may, of course, be more than one sensor.

The sensor is connected to control circuitry generally indicated by numeral (8) that controls the electric power supply circuit to the heating element (2). The sensor is configured to provide a first output associated with radiation sensed whilst a generally quiescent state of the surface prevails, and to provide a second output associated with radiation sensed when a generally turbulent state of the surface of the liquid prevails. Such turbulent state is associated with the onslaught of boiling of the liquid. The arrangement is such that the change of state from the first output to the second output is operative to trigger a switching action that, in this instance, is simply to open the power supply circuit to the heating element.

In this regard generally, it is envisaged that the technology that has been developed for the optical computer mouse may require only a little adaptation for application in terms of this invention. In such an instance, the sensor or sensors could be arranged to feed data concerning the reflected radiation received from the liquid surface as a “frame” very much along the lines of the optical mouse except that the frequency of creating the “frames” that is typically of the order of 1500 times per second in the case of an optical mouse could be drastically reduced anything from once the second upwards, according to design and production considerations. The data corresponding to the “frames” is fed to a rudimentary microprocessor (8a) forming part of the control circuit (8) that is programmed to switch from the first output to the second output when a predetermined change is detected. In such an instance the radiation source would typically be an LED and the sensors could be photodiodes but other optical mouse technologies may well be applicable with suitable an adaptation. The microprocessor could be programmed with one or more appropriate algorithms.

On the other hand, a simple light sensitive sensor may be employed that is set up to trigger from one state to the other when flickering of the reflected light reaches a level commensurate with the turbulence associated with the onslaught of boiling.

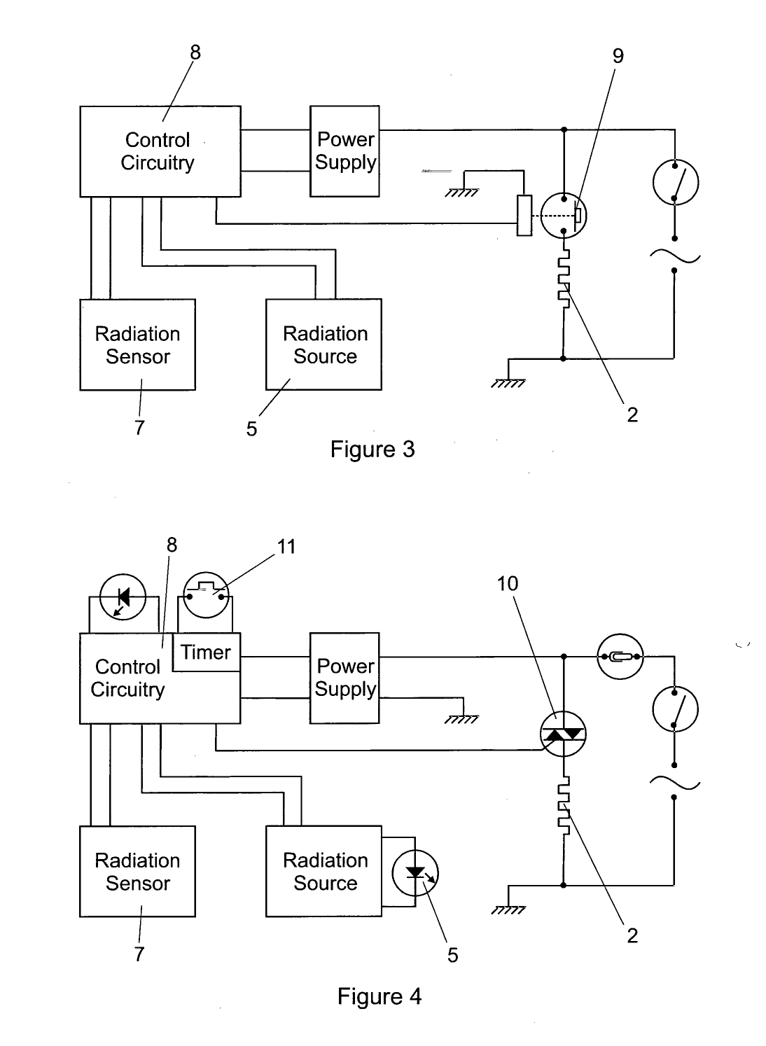

The electrical power supply may be controlled by any suitable switch that can be operated by the control circuitry. Thus, in the instance of the simple embodiment of the invention the block diagram of which is illustrated in FIG. 3, the switch is a simple self-holding pushbutton operated relay (9) whereby the power supply circuit is closed by manual operation of the pushbutton and the self-holding action is released when the output from sensor changes state as indicated above.

However, in the embodiment of the invention the block diagram of which is illustrated in FIG. 4, the power supply circuit is controlled by a triac (10) that is controlled by the control circuitry and in this instance closing of the circuit to the heating element is achieved by operation of a separate pushbutton switch (11).

Of course, the general degree of turbulence required to effect triggering may be set by setting the sensitivity of the sensor and its field of “vision”. In this regard it is to be noted that both the light source and that the sensor may be focused in order to achieve the most desirable objective. It may well be that turbulence in any particular kettle, or for that matter any other container, may be more prominent in one general position than in another and the focus of the sensor, in particular, and possibly also of the radiation source, may be adjusted accordingly.

It will further be quite apparent that the geometry of the kettle and, where one is present, the immersion heating element, may have a considerable effect on the turbulence created at the surface of water in the kettle and possibly even its location in plan view. It is, however, generally envisaged that the heating element should be located close to the bottom of the kettle or the bottom of any container in relation to which the invention is used. Such an arrangement should be aimed at minimising any substantial turbulence at the surface without substantial uniformity of temperature throughout the body of the water.

In the event that it is impractical to sense the onslaught of boiling adequately accurately, the sensor could be set to be somewhat more sensitive and a timer used to extend the supply of electricity to the heating element by a predetermined period of time to ensure that the boiling point has been adequately reached. Such a time delay would generally be short and, it is envisaged, of the order of about ½ to 3 seconds depending on the surrounding variables including kettle and heating element geometry, heat content of the various components and the most advantageous triggering point of the particular sensor used.

The electronic circuitry may also include a second time delay adapted to open said electric power supply circuit after a predetermined period of time corresponding to a predetermined maximum time period permitted by the timer for heating liquid in the relevant container, in this instance the kettle, to boiling point. Such an arrangement is intended to serve as a safety precaution against a kettle boiling dry and may obviate any necessity for having a thermal cut-out of the general nature presently employed in many kettles.

It will be appreciated that by providing a suitably translucent optionally coloured window (12) in the wall of the kettle, or its lid, the light emitted by a light source may also be used to serve as an indicator of the fact that the appliance is on.

It is to be mentioned that use of the present invention may render it attractive to manufacture an assembly of a heating element and control facility as one-piece in which instance the heating element (13) may be carried at the lower end of downwardly extending cold limbs (14) thereof, as illustrated in FIG. 2. This arrangement would also obviate any necessity for permanent seals to be formed below the water level in the sidewall of the kettle.

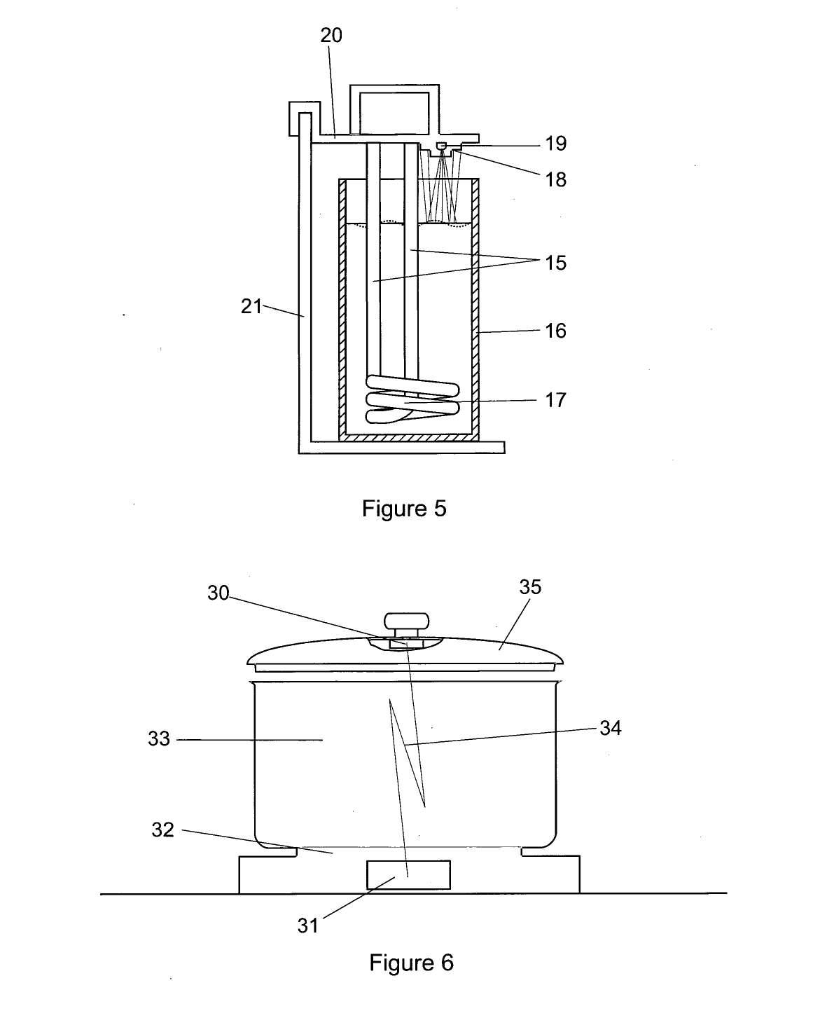

Of course, the invention is also applicable to an appliance of the type illustrated in FIG. 5 in which an immersion heating element with generally operatively upright limbs (15) extends into an open top of a container (16) in use with the hot section (17) of the heating element located towards the bottom of the relevant container. In this instance the sensor (18), radiation source (19), and the entire immersion heating element and control assembly can be carried by a base (20) that can be removably supported on a stand (21) forming an appliance of the general nature described in my said earlier patent application identified above.

Turning now to the third aspect of the invention, and with reference to FIGS. 6 and 8 of the accompanying drawings, the same principles may be applied to a boiling activated control device, in this instance a simmer control device, that consists of a sensor unit (30) and a control unit (31) that includes control circuitry for controlling an electrical power supply to an electric heating element, in this instance, a hot plate (32) on which a cooking vessel such as a pot (33) may, for example, be heated. In this instance the sensor unit and control unit have wireless communications means (34) for communicating the state of the output from the sensor unit to the control unit.

As will be apparent from the aforegoing, the sensor unit is adapted to be triggered by the state of turbulence of the surface of liquid in the pot. Thus, it could be set so that the power supply to the hotplate is turned off immediately turbulence at the surface of liquid triggers a change in output state. Once quiescent conditions return to the surface, power may once more be supplied to be heating element. In this manner a simmering condition can automatically be maintained over long periods of time. Of course, as indicated above, if it is found that switching occurs more frequently than is desirable, time delays can be employed to delay switching on of the power once more.

It will be quite clear that it will be preferable for the control unit to have its own power supply in the form of a battery and for control to be exercised at the control unit. The sensor unit can be attached to any suitable part of a cooking vessel and is, in the embodiment of the invention illustrated, attached centrally to the inside of the pot lid (35).

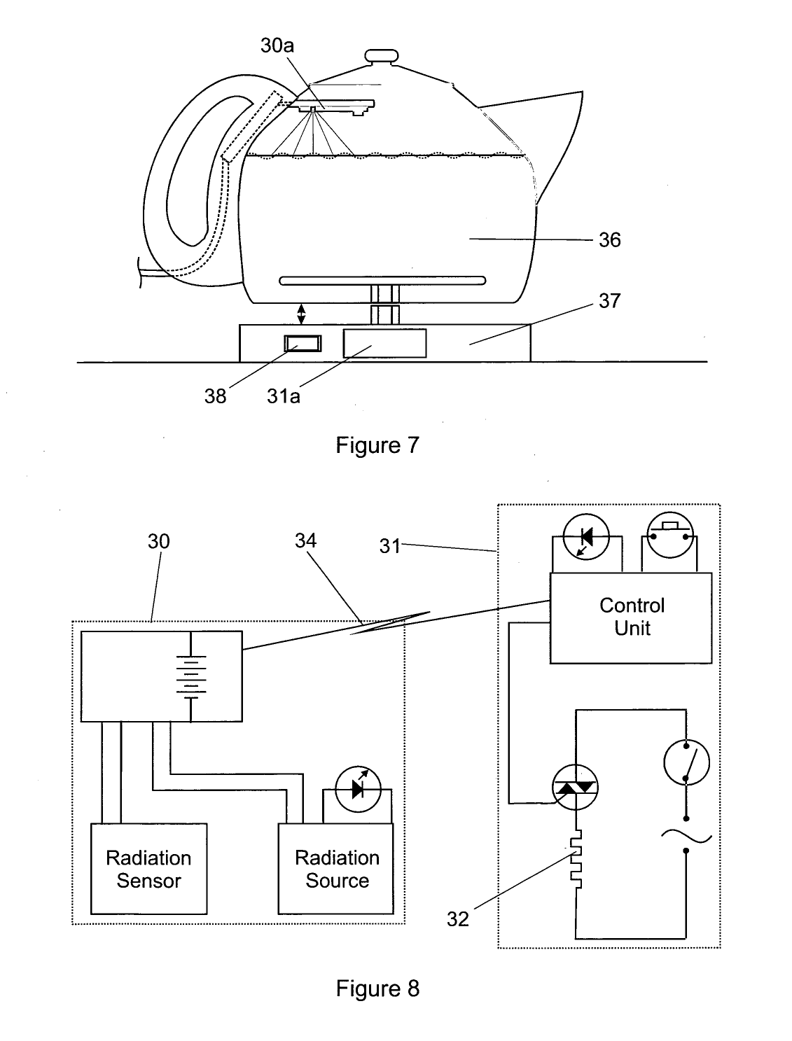

Of course a substantially identical boiling activated control device could be employed on a “cordless” kettle (36) that is releasable from a relatively stationary stand (37) in the usual way and as illustrated in FIG. 7. Such a boiling activated control device could simply comprise a sensor unit (30a) substantially as described above associated with the kettle itself and a control unit (31a) substantially as described above associated with the stationary stand. The base has a manually operable switch (38) for initiating closure of the power supply to the kettle and the control unit that is now associated with the stand would open that power supply when the change of state of the output from the sensor unit changes. This arrangement has the advantage that the power switching device is located in a more protected environment in the stand.

It will be understood that numerous variations can be made to the embodiments of the invention described above without departing from the scope hereof. In particular, the nature of the radiation employed may be varied widely and the invention is in no way limited to visible light as described in the embodiment of the invention. Indeed, any suitable radiation can be employed and even infrared radiation emitted spontaneously by the liquid itself may prove to be suitable insofar as the pattern of such radiation that corresponds to the turbulent state associated with the onslaught of boiling may be suitable to trigger a sensor of the general type described above when compared to the pattern corresponding to the quiescent state of the surface of the liquid.

1. An automatic switch for an electric domestic appliance comprising a base and associated electronic circuitry for inclusion in, or for association with, an electric power supply circuit that includes a heating element wherein liquid in a container may be heated to boiling temperature,
wherein the automatic switch comprises a sensor for monitoring radiation emanating from the surface of liquid to be boiled in a container and
wherein the sensor is configured to provide a first output associated with radiation sensed whilst a generally quiescent state of the surface prevails, and
to provide a second output associated with radiation sensed when a generally turbulent state of the surface of the liquid prevails
wherein such turbulent state is associated with the onslaught of boiling of the liquid,
wherein the change of state from the first output to the second output is operative to trigger a switching action in the electronic circuitry.

2. An automatic switch as claimed in claim 1 in which the radiation is radiation originating in the liquid to be boiled.

3. An automatic switch as claimed in claim 1 in which the radiation is reflected radiation originating with a radiation source forming part of the switch.

4. An automatic switch as claimed in claim 3 in which the radiation source is directed generally downwards towards the surface of liquid in the container in which instance the sensor is configured to sense reflected radiation.

5. An automatic switch as claimed in claim 3 in which the radiation source is a source of visible light.

6. An automatic switch as claimed in claim 1 in which the electronic circuitry includes a first time delay arranged to open said electric power supply circuit a predetermined time period after said change of state from the first output to the second output.

7. An automatic switch as claimed in claim 1 in which the electronic circuitry includes a second time delay adapted to open said electric power supply circuit after a predetermined period of time in excess of a predetermined maximum time period permitted by the timer for heating liquid in the container.

8. A water heating appliance including a container and an automatic switch comprising a base and electronic circuitry associated with an electric power supply circuit that includes a heating element for heating liquid within the container to boiling temperature,
wherein the automatic switch includes a sensor for monitoring radiation emanating from the surface of liquid to be boiled in the container and
wherein the sensor is configured to provide a first output associated with radiation sensed whilst a generally quiescent state of the surface prevails,
and to provide a second output associated with radiation sensed when a generally turbulent state of the surface of the liquid prevails
wherein such turbulent state is associated with the onslaught of boiling of the liquid,
wherein the change of state from the first output to the second output is operative to trigger a switching action in the electronic circuitry
the electrical heating element being located to heat a lower region of the container in which water to be heated is operatively contained and wherein the automatic switch is connected to open a power supply circuit to the electrical heating element consequent on said change of state to said second output
and a manually operable switch in the power supply circuit to initially close same and activate the automatic switch.

9. A boiling activated control device comprising a sensor unit and a control unit including control circuitry for controlling an electrical power supply to an electric heating element, the sensor unit and control unit having communications means for communicating from the sensor unit to the control unit,
wherein the sensor unit comprises a sensor for monitoring radiation emanating from the surface of liquid in a container that is operatively heated by the electric heating element and
wherein the sensor is configured to provide a first output associated with radiation sensed whilst a generally quiescent state of the surface prevails, and to provide a second output associated with radiation sensed when a generally turbulent state of the surface of the liquid prevails such turbulent state being associated with the onslaught of boiling of the liquid,
wherein the change of state from the first output to the second output is operatively communicated to the control unit to trigger a control action in the control circuitry.

10. A boiling activated control device as claimed in claim 9 in which the container is selected from a kettle of the so-called “cordless” type in which instance the sensor unit is associated with the kettle and the control unit is associated with a stand for the kettle that removably receives the kettle for use in which instance the control action is simply switching the power to the kettle off, and a cooking vessel in which instance the control unit is associated with a cooking energy source and the control action is switching electrical power on and off with any suitable time delays optionally being imposed by the control unit with a view to controlling the frequency of switching.

11. A boiling activated control device as claimed in claim 9 in which the communication between the sensor unit and the control unit is wireless.

12. A sensor for monitoring radiation emanating from a surface of liquid to be boiled in a container, the sensor being operative to provide a first output associated with radiation sensed whilst a generally quiescent state of the surface prevails, and to provide a second output associated with radiation sensed when a generally turbulent state of the surface of the liquid prevails such turbulent state being associated with the onslaught of boiling of the liquid, wherein the change of state from the first output to the second output is suitable for triggering a switching action in an electronically activated switching circuit.
